(19) United States
(12) Patent Application Publication
(10) Pub. No.: US 2004/0030963 A1
(43) Pub. Date: Feb. 12, 2004

(54) Method and apparatus for debugging computer program

(75) Inventor: David M. Ungar, Mountain View, CA (US)

Correspondence Address: David B. Ritchie, Thelen Reid & Priest LLP, P. O. Box 640640, San Jose, CA, 95164-0640, US

(73) Assignee: Sun Microsystems, Inc., a Delaware Corporation

(21) Appl. No.: 10/217,737

(22) Filed: Aug. 12, 2002

(51) Int. Cl. H02H 3/05; G06F 9/44

(52) U.S. Cl. 714/46; 717/125

(57) ABSTRACT

A method for debugging a computer program, includes (a) selecting a section of the computer program assembled in a machine-language, the computer program using a set of registers, the section including a plurality of machine-language instructions, (b) disassembling the plurality of machine-language instructions into mnemonic instructions, (c) automatically determining and selecting registers used by the mnemonic instructions corresponding to the section from among the set of registers, and (d) displaying the selected registers to a user. The method may further include displaying the mnemonic instructions, indicating a specific mnemonic instruction, and displaying a value of each of the selected registers before the execution of the indicated mnemonic instruction. The method may further include providing an option to a user to manually select registers to be displayed.

### FIELD OF THE INVENTION

This invention relates to tools for debugging a computer program. More particularly, the present invention relates to a method and apparatus for debugging machine-level instructions.

### BACKGROUND OF THE INVENTION

Computer programs are typically written by computer programmers in source code (high-level language) which is not directly executable by the computer. The source code must be converted into machine language by compilers, assemblers, and/or interpreters. A compiler is software that translates a program written in a high-level programming language into machine language. A compiler usually generates a program in an assembly language first, and then translates it into a machine language. Each assembly language statement (mnemonic instruction) is translated into one machine instruction by an assembler. For example, the assembly instruction “compare A, B” is translated into the machine instruction “compare contents of memory bytes XXXX-XXXX with YYYY-YYYY,” where the value of A is located in memory XXXX-XXXX, and the value of B is located in memory YYYY-YYYY. Actual machine code is in a binary form. The physical binary format of the machine instructions is specific to the computer (Central Processing Unit, or its family) on which the program runs. A disassembler is software that converts the machine language back into the assembly language.

Software development involves debugging processes in which a programmer iteratively makes changes in the source code or low-level code, and observes the behavior of the computer program, using software referred to as debuggers or debugging tools. When debugging low-level code, the programmer typically uses a debugger that disassembles the machine instructions into assembler-level instructions so as to be readable to humans. Since these low-level instructions manipulate the contents of registers, the programmer also needs to be aware of the contents of the registers during debugging the instructions. Modern processors, especially Reduced Instruction Set Computers (RISCs), such as those using the Scalable Performance ARChitecture (SPARC), developed by Sun Microsystems, Inc. of Palo Alto, Calif., and managed by SPARC International Inc. of San Jose, Calif., or the PowerPC architecture, jointly developed by IBM Corporation of Armonk, N.Y., Apple Computer, Inc. of Cupertino, Calif., and Motorola, Inc. of Schaumburg, Ill., have a number of general-purpose registers, typically, 32 registers.

A conventional debugger or debugging tool, such as GDB, available from Free Software Foundation, Inc. of Cambridge, Mass., or CodeWarrior, available from Metrowerks (subsidiary of Motorola, Inc.) of Austin, Tex., either display no registers by default setting or display all of the registers used in the program. That is, when a programmer wants to see some registers, either all of the registers are displayed, or the programmer has to input a command and manually specify the registers to be displayed. However, since debugging process is typically not performed onto the entire computer program at once, many of the registers are irrelevant in a given context, for example, for a given set of instructions under consideration. Manually selecting the registers to be displayed for each debugging process, as well as viewing the entire register including irrelevant registers on a limited display screen, is burdensome to programmers and developers.

### BRIEF DESCRIPTION OF THE INVENTION

A method for debugging a computer program, includes (a) selecting a section of the computer program assembled in a machine-language, the computer program using a set of registers, the section including a plurality of machine-language instructions, (b) disassembling the plurality of machine-language instructions into mnemonic instructions, (c) automatically determining and selecting registers used by the mnemonic instructions corresponding to the section from among the set of registers, and (d) displaying the selected registers to a user. The method may further include displaying the mnemonic instructions, indicating a specific mnemonic instruction, and displaying a value of each of the selected registers before the execution of the indicated mnemonic instruction. The method may further include providing an option to a user to manually select registers to be displayed.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a debugging environment for a computer program in accordance with one embodiment of the present invention.

FIG. 2 is a process flow diagram schematically illustrating a method for debugging a computer program in accordance with one embodiment of the present invention.

FIG. 3 a diagram illustrating an example of a display screen including a register display window and a source display window in accordance with one embodiment of the present invention.

FIG. 4 is a diagram illustrating an example of an option-setting window in accordance with one embodiment of the present invention.

FIG. 5 is a diagram illustrating an example of a display screen including a register display window and a source display window in accordance with one embodiment of the present invention.

### DETAILED DESCRIPTION

Embodiments of the present invention are described herein in the context of a method and apparatus for debugging a computer program. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In accordance with one embodiment of the present invention, the method may be implemented on a data processing computer such as a personal computer, workstation computer, mainframe computer, or high performance server running an OS such as Solaris® available from Sun Microsystems, Inc. of Palo Alto, Calif., Microsoft® Windows® XP and Windows® 2000, available form Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

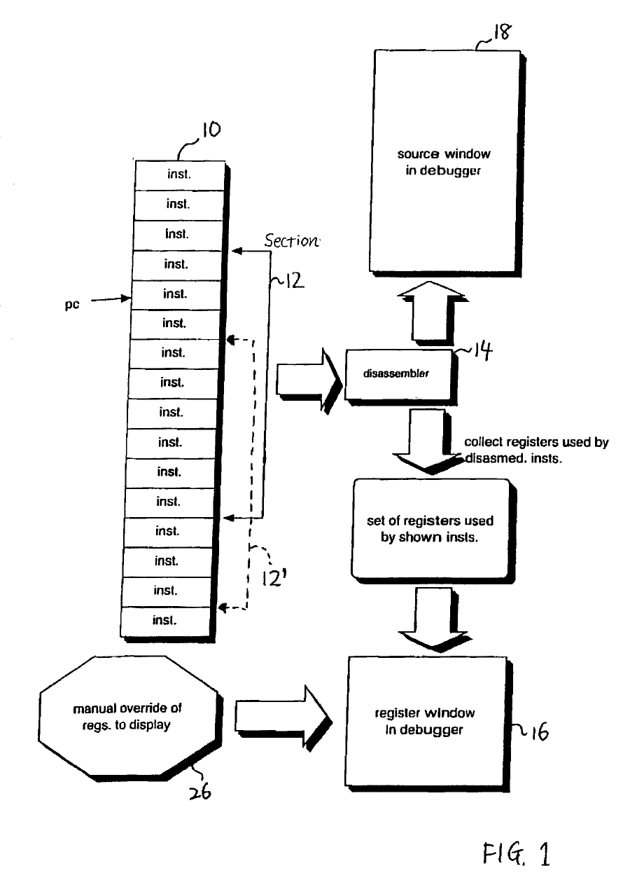

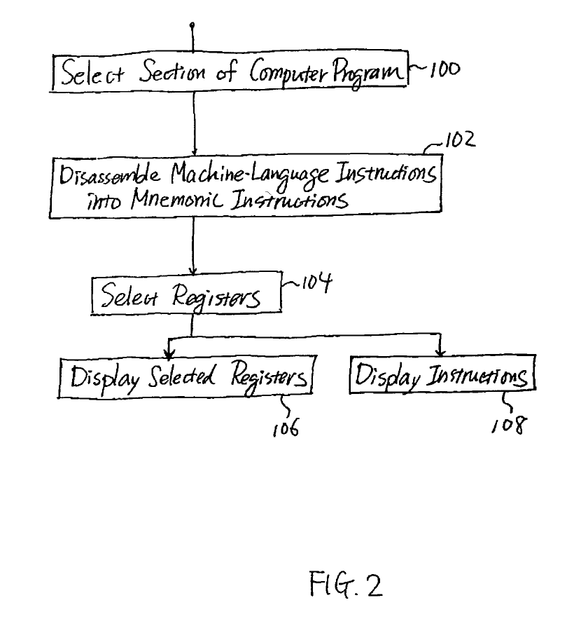

FIG. 1 schematically illustrates a low-level debugging environment for a computer program in accordance with one embodiment of the present invention. FIG. 2 schematically illustrates a method for debugging a computer program in accordance with one embodiment of the present invention. As shown in FIG. 1, a computer program under development/debugging is assembled into a machine language and is stored in a computer (PC) that executes the program. The computer program includes a set of machine (binary-coded) instructions 10, and it uses a set of registers (not shown) when it runs on the computer. Typically, such a set includes 32 registers for typical CPUs as described above.

First, a section 12 of the computer program, which includes a plurality of machine-language instructions, is selected (100), as shown in FIG. 2. Such a section 12 may be specified as an area of memory containing the machine instructions (also referred to as a “window”), or a specific number of instructions (“window width”) starting at a specified address of the memory. The section 12 of the program, or the number of the machine-language instructions, may be selected by the user, or in response to a user's selection through the debugger's user interface. As is well understood by one of ordinary skill in the art, a debugger typically includes a user interface with a display screen to show the program code or instructions, to receive commands from a user, and the like.

The machine-language instructions of the selected section 12 are disassembled into mnemonic instructions (102), using a disassembler 14. That is, the machine-language instructions in a binary-code are translated back into a human-readable mnemonic instructions. Then, the debugging tool automatically determines the registers used by the mnemonic instructions corresponding to the section (104). For example, such registers are selected from among the entire set of registers and collected into a list. The selected registers are displayed to a user (106), typically on a display screen (for example, in a register window 16 in FIG. 1) of the debugging tool interface. The mnemonic instructions in the section are also displayed to the user (108), typically on the display screen (for example, in a source window 18 in FIG. 1) of the debugger interface.

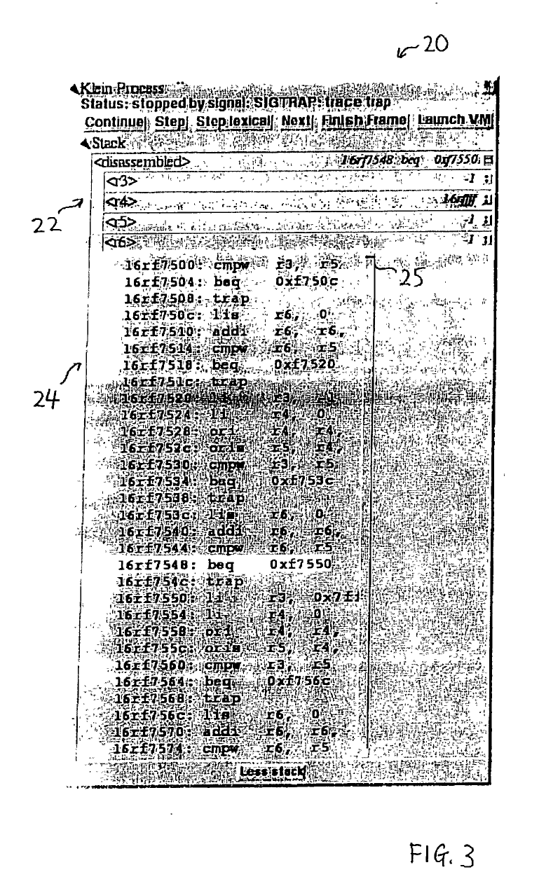

FIG. 3 schematically illustrates an example of the display screen 20 including a register display window 22 and a source display window 24, in accordance with one embodiment of the present invention. The register display window 22 displays a list of registers (<r3>, <r4>, <r5>, and <r6>) that are used by the mnemonic instructions (such as “cmpw”, “li”, “addi”) displayed in the source display window 24. The source display window 24 typically shows a list of a specific number of mnemonic instructions corresponding to the section of the computer program in the machine language.

As shown in FIG. 3, the list of registers also includes a value of each register (such as “−1”, “16rffff”). Each register holds a certain value therein in accordance with execution of the instructions using that register, and the value of a register is different at a different step of execution. Thus, the values of the registers are that of a certain step of execution. For example, such a certain step of execution may be specified as before the execution of a specific mnemonic instruction (“16rf7548: beg” in this example) indicated in the source display window 24. Typically, a specific mnemonic instruction is indicated in response to a user selection. Such indication of a specific instruction includes “highlighting” the instruction, as shown in FIG. 3, underlining the instruction, displaying the instruction with a different color or font type (such as a bold type), or any other manner to make the specified instruction conspicuous from others.

The number of the mnemonic instructions to be displayed in the source display window 24 may also be specified by a user, or may be set by the debugging tool. In addition, as shown in FIG. 3, the debugging tool may also include a so-called scroll bar 25, or any other tool device to slide the “window” so as to a different set of mnemonic instructions are displayed in the source display window 24. This “sliding window” corresponds to selecting a new section, for example, a section 12′ of the computer program as shown in FIG. 1. When a new set of machine-language instructions is selected, the disassembling and the automatic determination/selection of the registers are performed and the new set of mnemonic instructions and the newly selected registers are displayed on the display screen.

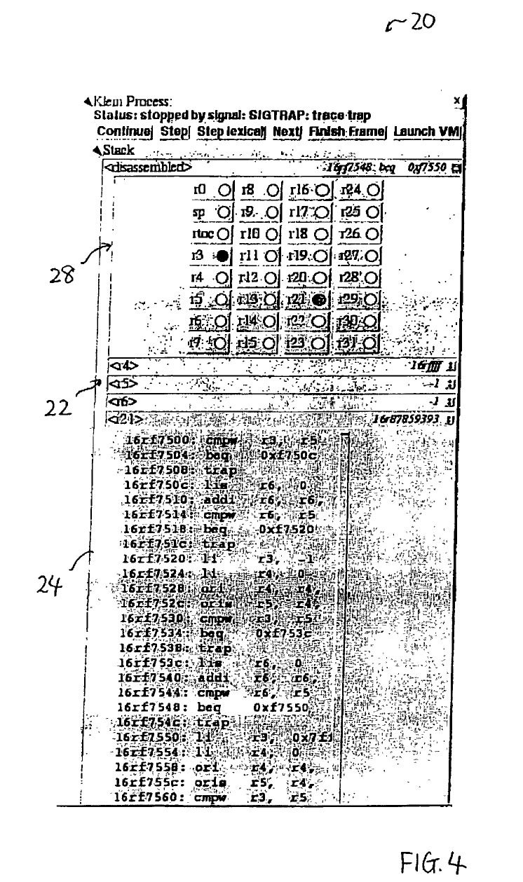

The above-described automatic determination/selection and display of the registers may be set as a default operation of the debugging tool. As shown in FIG. 1, an option to manually override such a default setting 26 may be provided to the user in accordance with one embodiment of the present invention. FIG. 4 schematically illustrates such an option-setting window 28 in the same example shown in FIG. 3. The option-setting window 28 displays all registers implemented by the target processor. In this example, 32 registers r0 to r31 are shown. However, the number of the registers is not limited to this number, and the number of registers is fixed by the architecture of the target processor.

As shown in FIG. 4, the option-setting window 28 may display the registers with their display status information, for example, default (automatic selection), display (add to the register list), hide or suppress (delete from the register list), and the like. The display status of a register can be changed in response to a user's selection. That is, the user can manually set the display status through the option-setting window 28, overriding the default setting. According to the new display status, a new list of registers is automatically generated and displayed in the register display window 22.

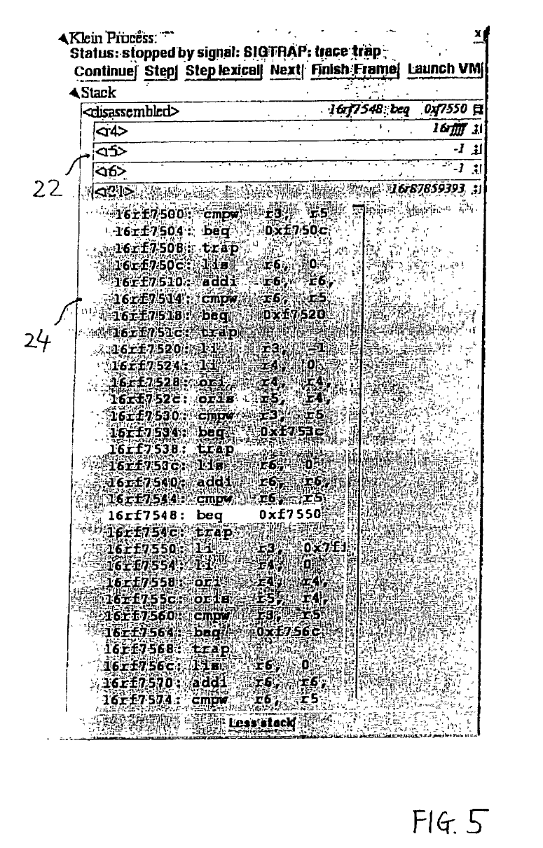

One example of the manual setting is to always display a user-selected register regardless of the selected section of the computer program. For example, as shown in FIG. 4, register r21 is selected as such a register to be displayed, and thus it is now added to the list of the selected registers in the register display window 22 although the register r21 does not appear in the source display window 24. This feature is useful when, for example, the value of a specific register need to be monitored during debugging processes. Another example of the manual setting is not to display a user-selected register regardless of the selected section of the computer program. For example, register r3 is selected as such a register to suppress display, and thus it is now deleted from the list of the selected registers in the register display window 22 (although the register r3 does appear in the source display window 24). FIG. 5 schematically illustrates the register display window 22 and the source display window 24 on the display screen when the option-setting window 28 has been closed.

As shown in FIG. 4, the manual setting of the display status may be conducted using register “buttons” displayed in the option-setting window 28. A list of the display status of each register may be shown in a “popup” window to be selected by the user. Alternatively, the display status may be indicated by the color associated with the register button, as shown in FIG. 4, and the selected display status may be toggled with the user's click on the button. However, the manner of the manual selection is illustrated by way of example, and is not intended to be exhaustive or limiting in any way.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for debugging a computer program, said method comprising:
selecting a section of the computer program assembled in a machine-language, the computer program using a set of registers, the section including a plurality of machine-language instructions;
disassembling the plurality of machine-language instructions into mnemonic instructions;
automatically selecting registers used by the mnemonic instructions corresponding to the section from among the set of registers; and
displaying the selected registers to a user.

2. A method in accordance with claim 1 wherein the section of the computer program is selected in response to a user's selection.

3. A method in accordance with claim 1, further comprising:
displaying the mnemonic instructions within the section;
indicating a specific mnemonic instruction; and
displaying a value of each of the selected registers before the execution of the indicated mnemonic instruction.

4. A method in accordance with claim 1, further comprising:
providing an option to the user to manually select registers to be displayed.

5. A method in accordance with claim 1 wherein said displaying includes:
displaying a list of selected registers.

6. A method in accordance with claim 5, further comprising:
displaying all registers used by the computer program to a user;
receiving the user's selection of a register to display; and
adding the user-selected register to the list of selected registers.

7. A method in accordance with claim 5, further comprising:
displaying all registers used by the computer program to a user;
receiving the user's selection of a register to suppress display; and
deleting the user-selected register from the list of selected registers.

8. A method in accordance with claim 1, further comprising:
displaying all registers used by the computer program with display status information thereof; and
changing the display status of a register in response to a user's selection.

9. A method in accordance with claim 8, further comprising:
generating and displaying a list of registers in accordance with the display status of the registers.

10. A method in accordance with claim 1, further comprising:
shifting the section so as to include a new set of machine-language instructions; and
performing said disassembling, said automatically selecting, and said displaying for the new set of instructions.

11. An apparatus for debugging a computer program, said apparatus comprising:
means for selecting a section of the computer program assembled in a machine-language, the computer program using a set of registers, the section including a plurality of machine-language instructions;
means for disassembling the plurality of machine-language instructions into mnemonic instructions;
means for automatically selecting registers used by the mnemonic instructions corresponding to the section from among the set of registers; and
means for displaying the selected registers to a user.

12. An apparatus in accordance with claim 11 wherein the section of the computer program is selected in response to a user's selection.

13. An apparatus in accordance with claim 11, further comprising:
means for displaying the mnemonic instructions within the section;
means for indicating a specific mnemonic instruction; and
means for displaying a value of each of the selected registers before the execution of the indicated mnemonic instruction.

14. An apparatus in accordance with claim 13 wherein said means for indicating a specific mnemonic instruction performs in response to a user's selection.

15. An apparatus in accordance with claim 11, further comprising:
means for providing an option to the user to manually select registers to be displayed.

16. An apparatus in accordance with claim 11 wherein said means for displaying includes:
means for displaying a list of selected registers.

17. An apparatus in accordance with claim 16, further comprising:
means for displaying all registers used by the computer program to a user;
means for receiving the user's selection of a register to display; and
means for adding the user-selected register to the list of selected registers.

18. An apparatus in accordance with claim 16, further comprising:
means for displaying all registers used by the computer program to a user;
means for receiving the user's selection of a register to suppress display; and
means for deleting the user-selected register from the list of selected registers.

19. An apparatus in accordance with claim 11, further comprising:
means for displaying all registers used by the computer program with display status information thereof; and
means for changing the display status of a register in response to a user's selection.

20. An apparatus in accordance with claim 19, further comprising:
means for generating and displaying a list of registers in accordance with the display status of the registers.

21. An apparatus in accordance with claim 11, further comprising:
means for shifting the section so as to include a new set of machine-language instructions; and
means for performing said disassembling, said automatically selecting, and said displaying for the new set of instructions.

22. A program storage device readable by a machine, tangibly embodying a program of instructions executable by the machine to perform a method for debugging a computer program, the method comprising:
selecting a section of the computer program assembled in a machine-language, the computer program using a set of registers, the section including a plurality of machine-language instructions;
disassembling the plurality of machine-language instructions into mnemonic instructions;
automatically selecting registers used by the mnemonic instructions corresponding to the section from among the set of registers; and
displaying the selected registers to a user.
